(19) United States
(12) Patent Application Publication
(10) Pub. No.: US 2013/0260800 A1
(43) Pub. Date: Oct. 3, 2013

(54) INFORMATION PROCESSING APPARATUS, INFORMATION PROCESSING METHOD, AND PROGRAM

(71) Applicant: SONY CORPORATION, Tokyo (JP)

(72) Inventors: Takeshi Asakawa, Chiba (JP); Yuichiro Koyama, Tokyo (JP); Shinako Matsuyama, Tokyo (JP)

(73) Assignee: Sony Corporation, Tokyo (JP)

(21) Appl. No.: 13/779,256

(22) Filed: Feb. 27, 2013

(30) Foreign Application Priority Data
Mar. 30, 2012 (JP) 2012-080994

(51) Int. Cl. H04W 4/02

(52) U.S. Cl. CPC H04W 4/02
USPC 455/457

(57) ABSTRACT

There is provided an information processing apparatus, including a first information acquisition section which acquires position information related to a present position of a user and time information which shows a present time at the present position, a second information acquisition section which acquires body clock information related to a body clock based on biological information of the user, and a display control section which displays a map image on a display section. The display control section identifies and displays a location corresponding to a time difference between the present time and a time of the body clock, with respect to the present position, on the map image.

### BACKGROUND

The present disclosure relates to an information processing apparatus, an information processing method, and a program.

In recent years, it has been well known that the state of a person's body fluctuates along with his or her body clock, and attention has been drawn to the importance of the body clock. Also, from the view point of health, in the case where the body clock is prevented from being shifted or the body clock is unavoidably shifted, it may be necessary to shift the body clock so as to suppress a burden on the body.

JP H05-15595A discloses a system which controls a biological rhythm by measuring the biological rhythm and adding an appropriate external stimulus. A method is disclosed in this system which adjusts a circadian rhythm in accordance with a working system and a time difference, or realizes an optimum awakening level which matches a target to a time during the day of an important sports game or business negotiation.

### SUMMARY

Incidentally, there are no second, minute or hour hands of an ordinary clock in the body clock, and a digital numerical display may not be performed. Accordingly, even if the body clock is temporarily adjusted, a user may not be able to recognize the state of his or her body clock. Further, JP H05-15595A described above does not pay any attention whatsoever to visualizing the state of the body clock.

Here, the present disclosure proposes a method in which a user intuitively recognizes the state of his or her body clock.

According to an embodiment of the present disclosure, there is provided an information processing apparatus, including a first information acquisition section which acquires position information related to a present position of a user and time information which shows a present time at the present position, a second information acquisition section which acquires body clock information related to a body clock based on biological information of the user, and a display control section which displays a map image on a display section. The display control section identifies and displays a location corresponding to a time difference between the present time and a time of the body clock, with respect to the present position, on the map image.

According to such a configuration, the display control section identifies a location corresponding to a time difference between the present time and the time of the body clock, with respect to the present position of the user, on a map image displayed on the display section. In this way, the user can intuitively perceive a deviation of his or her body clock, by observing the difference between the identified location and the present position on a map image displayed on the display section. Further, when the deviation of the body clock is adjusted, the degree of adjustment can be intuitively perceived by observing the difference between the identified location and the present position on the map image.

Further, according to an embodiment of the present disclosure, there is provided an information processing method, including acquiring position information related to a present position of a user and time information which shows a present time at the present position, acquiring body clock information related to a body clock based on biological information of the user, displaying, on a display section, a map image including the present position and a location that includes a time difference with the present position, and identifying and displaying, on the map image, a location corresponding to a time difference between the present time and a time of the body clock, with respect to the present position.

Further, according to an embodiment of the present disclosure, there is provided a program for causing a computer to execute acquiring position information related to a present position of a user and time information which shows a present time at the present position, acquiring body clock information related to a body clock based on biological information of the user, displaying a map image on a display section, and identifying and displaying, on the map image, a location corresponding to a time difference between the present time and a time of the body clock, with respect to the present position.

According to the embodiment of the present disclosure such as described above, it is possible for a user to intuitively recognize the state of his or her body clock.

### BRIEF DESCRIPTION OF THE DRAWINGS

FIG. 1 is a figure which shows an example of a functional configuration of the information processing apparatus 100 according to the embodiments of the present disclosure;

FIG. 2 is a figure which shows an example of a display mode of a map displayed on the display section 120 according to the embodiments of the present disclosure;

FIG. 3 is a figure which shows an example of a display mode of a map displayed on the display section 120 according to the embodiments of the present disclosure;

FIG. 4 is a figure which shows an example of a display mode of a map displayed on the display section 120 according to the embodiments of the present disclosure;

FIG. 5 is a figure which shows an example of a display mode of a map displayed on the display section 120 according to the embodiments of the present disclosure;

FIG. 6 is a flow chart for describing an operation example of the information processing apparatus 100 according to the embodiments of the present disclosure; and

FIG. 7 is an explanatory diagram which shows a hardware configuration example of the information processing apparatus 100 according to the embodiments of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Configuration example of the information processing apparatus

2. Operation example of the information processing apparatus

3. Hardware configuration

4. Conclusion

### 1. CONFIGURATION EXAMPLE OF THE INFORMATION PROCESSING APPARATUS

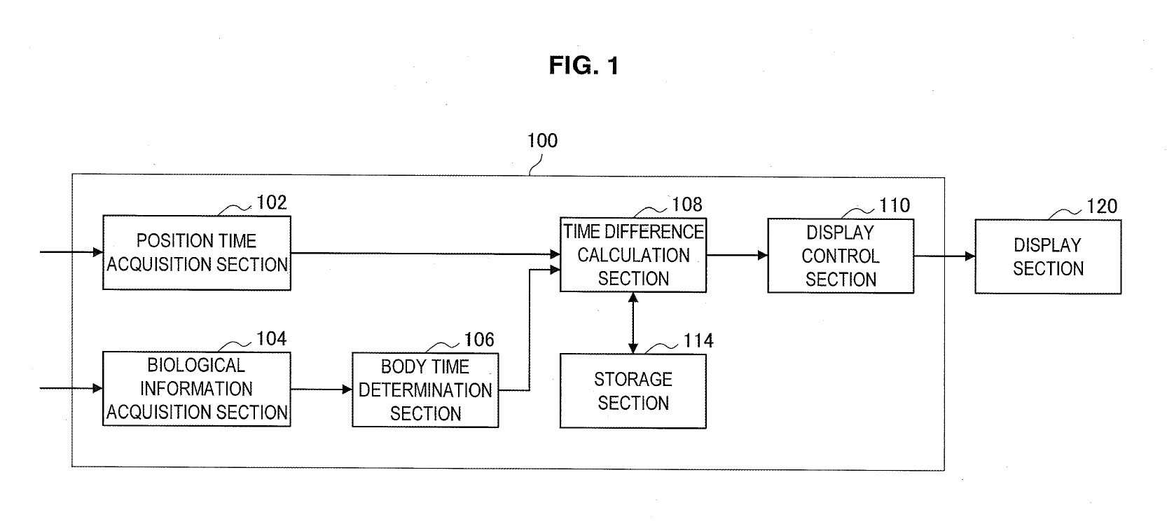

A configuration example of an information processing apparatus 100 according to the embodiments of the present disclosure will be described with reference to FIG. 1. FIG. 1 is a figure which shows an example of a functional configuration of the information processing apparatus 100 according to the embodiments of the present disclosure.

The information processing apparatus 100 is a portable terminal such as a smart phone or a mobile phone, for example. As shown in FIG. 1, the information processing apparatus 100 has a position time acquisition section 102 which is an example of a first information acquisition section, a biological information acquisition section 104 which is an example of a second information acquisition section, a body time determination section 106, a time difference calculation section 108, and a display control section 110. These functional configurations are implemented by a CPU of the information processing apparatus 100.

### (Position Time Acquisition Section 102)

The position time acquisition section 102 acquires position information related to the user's present position and time information which shows the present time at the present position. The information processing apparatus 100 has, for example, an internal clock, and the position time acquisition section 102 acquires the present time from the internal clock. Further, the information processing apparatus 100 has, for example, a GPS, and the position time acquisition section 102 acquires the present position from the GPS. The position time acquisition section 102 outputs information related to the acquired present time and present position to the time difference calculation section 108.

### (Biological Information Acquisition Section 104)

The biological information acquisition section 104 acquires biological information related to the user's body clock at the present time. The biological information is information capable of being input by the user to the information processing apparatus 100 through an input section. Here, the biological information is, for example, information related to a deep body temperature, blood, hair roots, metabolism or the like from the user's body. Also, the biological information acquisition section 104 outputs the acquired biological information to the body time determination section 106.

### (Body Time Determination Section 106)

The body time determination section 106 determines the time of the user's body clock at the present time, based on the biological information input from the biological information acquisition section 104. For example, the body time determination section 106 determines the time of the user's body clock, based on information of the deep body temperature. The body time determination section 106 may determine in real time the time of the user's body clock, based on the biological information sequentially input from the biological information acquisition section 104. The body time determination section 106 outputs a determination result to the time difference calculation section 108.

### (Time Difference Calculation Section 108)

The time difference calculation section 108 calculates a time difference between the present time input from the position time acquisition section 102 and the time of the body clock determined from the body time determination section 106. For example, in the case where the time of the user's body clock corresponds to the actual time, the time difference will be 0, and in the case where the time of the user's body clock has deviated from the actual time, there will be a time difference. Also, the time difference calculation section 108 outputs a calculation result to the display control section 110.

The time difference calculation section 108 may calculate the time difference in real time, based on the information sequentially input from the position time acquisition section 102 and the body time determination section 106. In such a case, the time difference calculation section 108 stores the sequentially calculated results in a storage section 114. Further, the time difference calculation section 108 judges whether or not a fluctuation width of the time difference is larger than a predetermined value, based on the calculation result stored in the storage section 114. Since it is considered to be harmful to the user's health in the case where the fluctuation width of the time difference is large, a health state of the user can also be determined by the above described judgment.

### (Display Control Section 110)

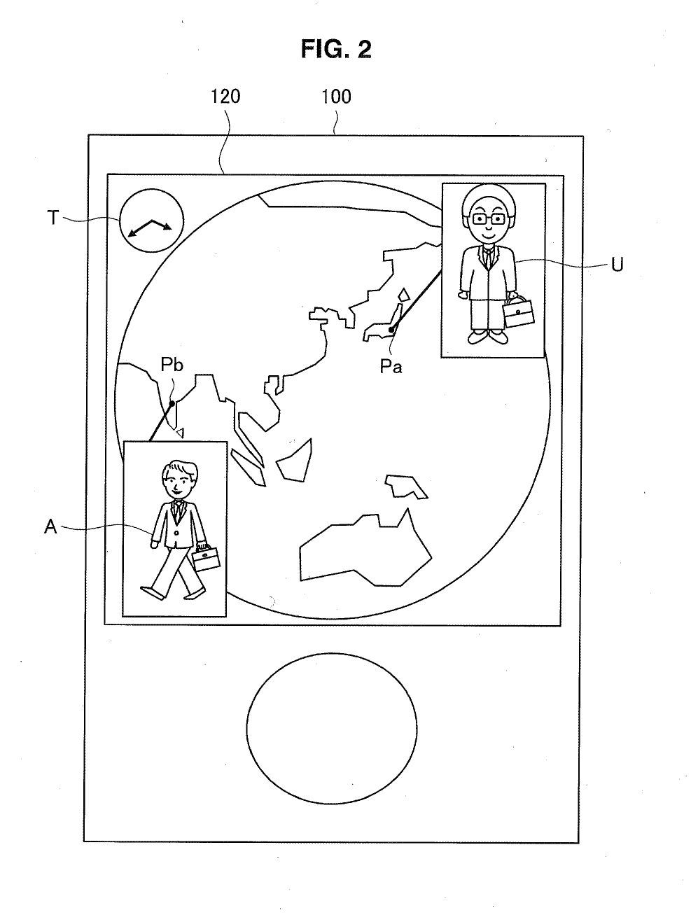

The display control section 110 controls the display by a display section 120. Characters, images or the like are displayed on the display section 120. For example, the display section 120 displays a map image (hereinafter, simply called a map) corresponding to a world map of the earth, which is shown in FIGS. 2 to 5. The regions included on the world map have well known time differences. For example, Japan has a time ahead of that of Europe. FIGS. 2 to 5 are figures which show examples of display modes of a map displayed on the display section 120 according to the embodiments of the present disclosure.

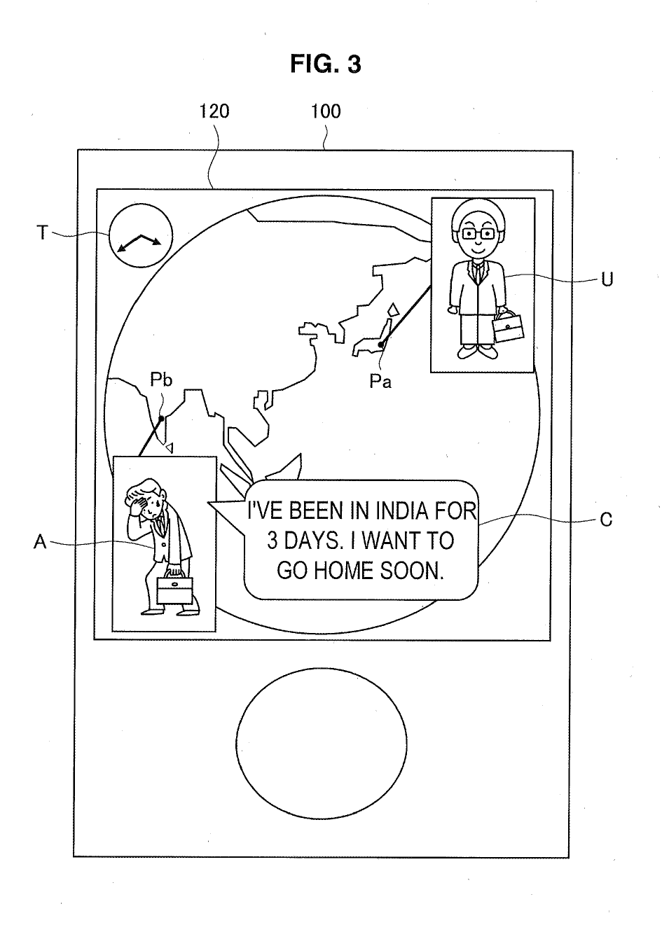

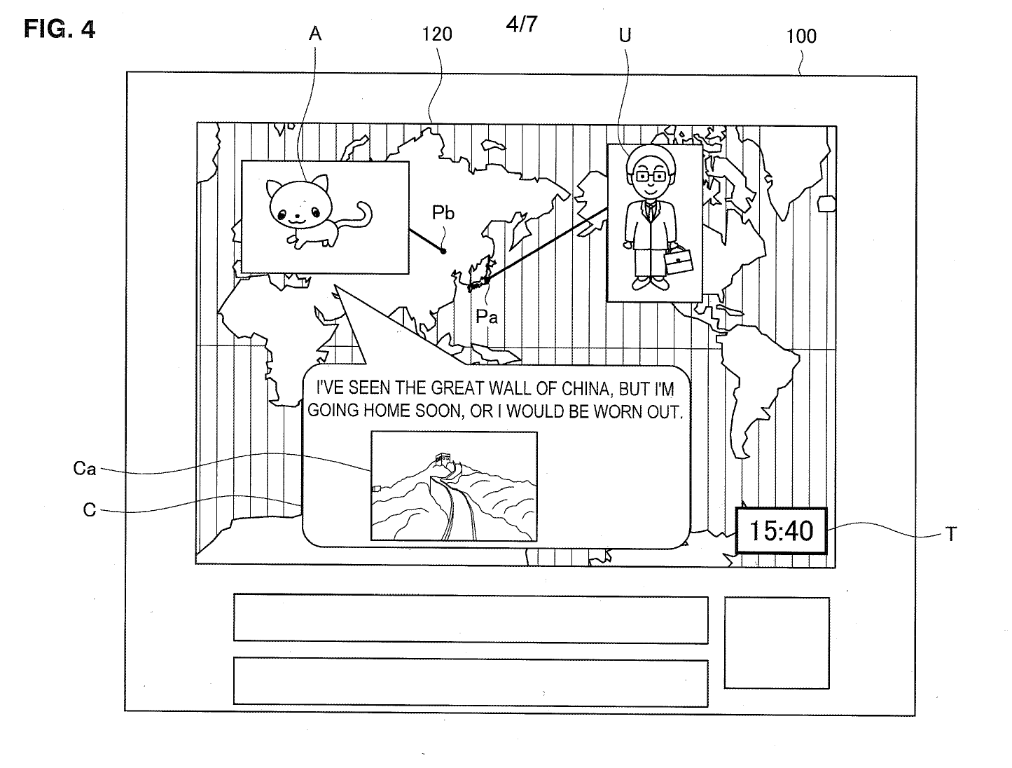

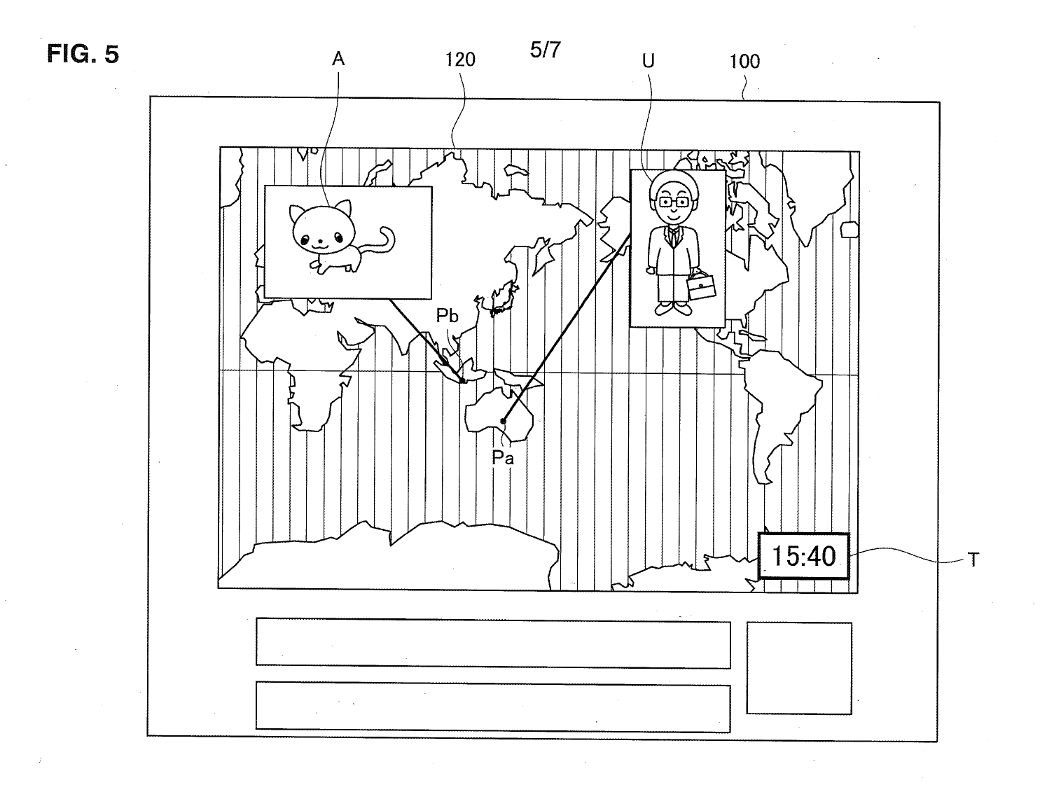

The maps of FIGS. 2 and 3 are maps which show the earth in a spherical shape, and the maps of FIGS. 4 and 5 are maps which show the earth in a planar shape. In FIGS. 2 and 3, the map can rotate by the user performing a touch operation on the display section 120. In this way, the user can observe the entire world by rotating the map. Note that the display modes of the world maps shown in FIGS. 2 to 5 are merely examples, and may be other display modes.

The display control section 110 displays the user's present position Pa on the map displayed on the display section 120. In FIGS. 2 to 5, an image U, which shows the user on the screen, and the user's present position Pa are shown. In this way, the user can intuitively perceive his or her present position by observing the display section 120.

The display control section 110 identifies and displays a location corresponding to the time difference relative to the present position, on the map, based on the time difference which is the calculation result input from the time difference calculation section 108. Specifically, the display control section 110, as shown in FIG. 2, displays an avatar A on a location Pb corresponding to the time difference relative to the present position, on the map.

For example, in FIGS. 2 and 3, the time of the body clock is later than the actual time, and the avatar A is displayed in India which is the location Pb corresponding to the time difference. Here, the avatar A is the user expressed in a simulated manner, and it is possible for an expression, operation or the like to change on a display screen. For example, the person shown in FIGS. 2 and 3 is displayed as the avatar. However, the avatar is not limited to a person, and may be an animal, for example. In this way, the user can intuitively perceive the state of his or her body clock by observing the avatar A, which shows the time difference displayed on the display section 120. As a result, the user can perform actions such as a strategy (for example, exposure to light) for returning the time of his or her body clock back to a normal time.

Since the time difference as described above is sequentially calculated in real time, the position of the avatar A displayed on the map changes according to the time difference. In this way, the user can perceive the state of his or her body clock in real time.

The display control section 110 may display the present time along with the map. The time T which shows the present time is shown in FIGS. 2 to 5. Further, the display control section 110 may display the degree of deviation of the body clock from the present time. Specifically, the display control section 110 displays a color corresponding to the degree of deviation of the body clock. For example, the display control section 110 displays the time T in light blue in the case where the degree of deviation of the body clock is less than a predetermined threshold, and displays the time T in red in the case where the degree of deviation of the body clock is large. In this way, the user can intuitively perceive whether the deviation of his or her body clock is in a state falling within an allowable range, or is in a dangerous state.

The display control section 110 may change the display mode of the avatar A to be displayed on the map according to fluctuations of the time difference. For example, in the case where the fluctuations of the time difference are small, the display control section 110 displays the avatar A in a healthy state, as shown in FIG. 2, and in the case where the fluctuations of the time difference are larger than a threshold, the display control section 110 displays the avatar A as being tired, as shown in FIG. 3. In this way, the user can intuitively perceive that there are large fluctuations in his or her body clock. Note that the display control section 110 preferably changes the display mode of the avatar A according to the fluctuations of the time difference within a predetermined time period in which the user is using the information processing apparatus. In this way, the user can intuitively perceive fluctuations of his or her body clock in a desired time period.

The display control section 110 may display, along with the map, advice information for positioning the position of the avatar at the present position. That is, advice information for returning the user's body clock back to normal is displayed. Advice information is shown in FIG. 3 by character information C. According to the display of FIG. 3, it is understood that three days have passed in a state where the body clock has just deviated a predetermined time. Accordingly, the user is encouraged by the displayed advice information, and takes measures for returning his or her body clock back to normal.

The display control section 110 may display, along with the map, information related to the body clock and to health. For example, the display control section 110 may display information related to the time zone or the like of the body clock with the highest performance when playing a sport. In this way, the user can acquire trivia related to the body clock and to health.

The display control section 110 may display region information of the location Pb which shows the time difference. There can be sightseeing information or the like of the identified location (for example, information related to sightseeing spots such as World Heritage sites) as region information. An image Ca, which shows a sightseeing spot of the location identified according to the time difference, is shown as region information in FIG. 4. In this way, since the user can acquire information related to other locations so as to simulate traveling, an entertainment property of using the information processing apparatus 100 can be enhanced.

The map displayed on the display section 120 includes the northern and the southern hemispheres of the earth. Also, the display control section 110 identifies and displays a location corresponding to the time difference on the side of the northern or southern hemisphere which includes the user's present position, relative to the present position, on the map. For example, in the case where the user's present position is in the northern hemisphere, the location Pb corresponding to the time difference will also be in the northern hemisphere as shown in FIG. 4, and in the case where the user's present position is in the southern hemisphere, the location Pb corresponding to the time difference will also be in the southern hemisphere as shown in FIG. 5. The seasons are different in the northern and southern hemispheres. That is, the time during the day when the sun is out will tend to be different in the northern and southern hemispheres, and the state of the body clock will also tend to be different. Accordingly, the avatar is displayed in a location in the northern or southern hemisphere corresponding to the user's present position, so as to not provide misleading information to the user.

Note that while the avatar A is displayed on the map in the above description, it is not limited to this. For example, the location corresponding to the deviation of the user's body clock relative to the user's present position may be identified by a figure such as a mark on the map. In such a case, the user can intuitively perceive the deviation of his or her body clock.

Further, while the user's present position Pa is shown on the map in the above description, it is not limited to this. In the case where the user's present position is clear, the user's present position may not be shown on the map. In such a case, the user can intuitively perceive the deviation of his or her body clock even if the present position is not displayed, by the avatar A displayed on the map.

### 2. OPERATION EXAMPLE OF THE INFORMATION PROCESSING APPARATUS

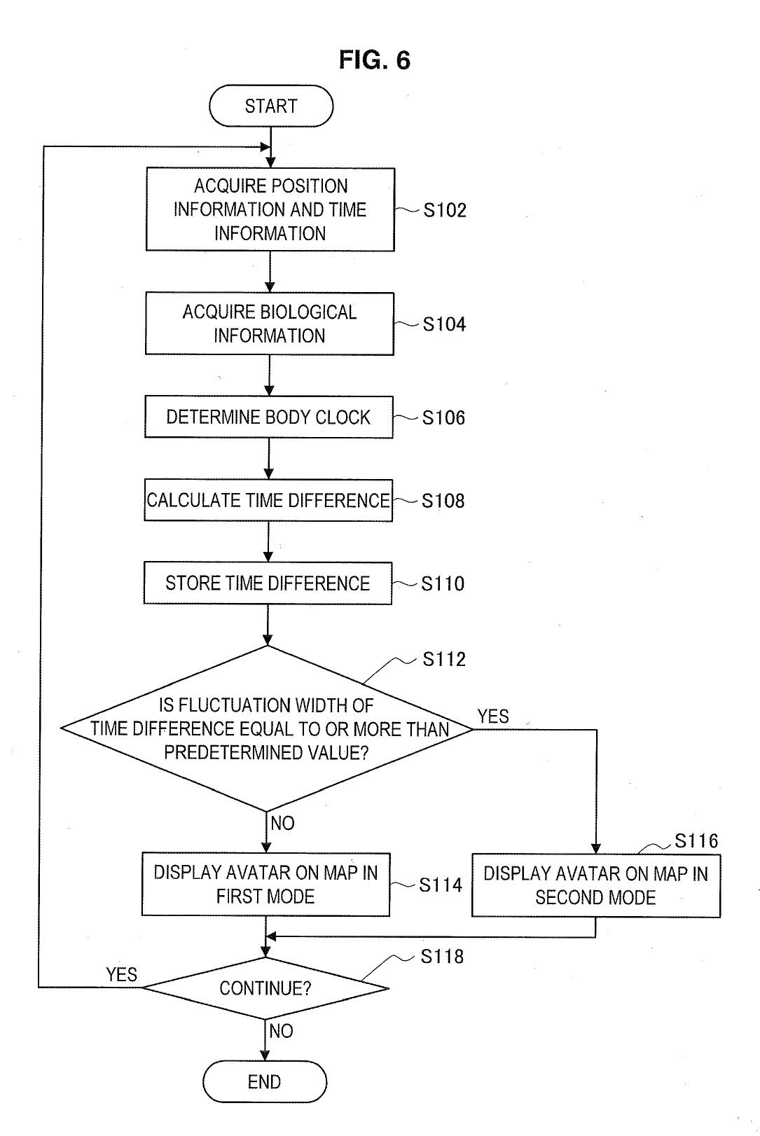

An operation example of the information processing apparatus 100 according to the embodiments of the present disclosure will be described with reference to FIG. 6. FIG. 6 is a flow chart for describing an operation example of the information processing apparatus 100 according to the embodiments of the present disclosure.

The operation example shown in FIG. 6 is implemented by a CPU of the information processing apparatus 100 executing a program stored in a ROM. Note that the executed program may be stored on a recording medium such as a CD (Compact Disk), DVD (Digital Versatile Disk), or memory card, and may be downloaded from a server or the like through the internet.

First, the position time acquisition section 102 acquires information related to the present time and the user's present position (step S102). For example, the position time acquisition section 102 acquires the present time from the body clock, and acquires the present position from the GPS.

Next, the biological information acquisition section 104 acquires biological information related to the user's body clock at the present time (step S104). The biological information acquisition section 104 acquires information related to a deep body temperature, blood, hair roots, or metabolism from the user's body as biological information.

Next, the body time determination section 106 determines the time of the user's body clock at the present time, based on the acquired biological information (step S106).

Next, the time difference calculation section 108 calculates the time difference between the present time acquired in step S102 and the time of the body clock determined in step S106 (step S108). That is, the time difference calculation section 108 judges to what extent the body clock has deviated. Then, the time difference calculation section 108 stores the calculated time difference in the storage section 114 (step S110).

Next, the time difference calculation section 108 judges whether or not the fluctuation width of the time difference is equal to or more than a predetermined value (step S112). That is, the time difference calculation section 108 judges whether or not the fluctuation of the time difference of a predetermined period, for example, stored in the storage section 114, is larger than a predetermined value.

In the case where the fluctuation width of the time difference is not equal to or more than the predetermined value in step S112 (No), the display control section 110 displays an avatar in an ordinary mode (first mode) at the location (location Pb shown in FIGS. 2 to 5) corresponding to the time difference relative to the user's present position, on the map (step S114). That is, the deviation of the body clock is judged to be temporary, and the display control section 110 displays the avatar in a healthy state.

In the case where the fluctuation width of the time difference is equal to or more than the predetermined value in step S112 (Yes), the display control section 110 displays the avatar in a tired mode (second mode) at the location (location Pb shown in FIGS. 2 to 5) corresponding to the time difference relative to the user's present position, on the map (step S116). That is, the deviation of the body clock is judged to be very harmful to the user's health, and the display control section 110 displays the avatar in a tired state.

In this way, the user can intuitively perceive the deviation of his or her body clock, by the avatar displayed at the location on the map corresponding to the time difference relative to the user's present position. Note that region information of the location where the avatar is positioned, and advice information for moving the avatar to the present position, may be displayed along with the display of the avatar.

Then, in the case where the process continues (step S118: Yes), the processes of steps S102 to S116 described above are repeated. That is, the display control section 110 displays the avatar in real time, according to the deviation of the body clock. On the other hand, in the case where the process does not continue (step S118: No), the operation of the information processing apparatus 100 is completed.

Note that while the deviation of the time difference is stored in the storage section 114 and the fluctuation of the deviation of the body clock is judged in the above description, such process may be omitted. In this way, the processing load of the information processing apparatus 100 is reduced, and the use regions in the storage section 114 can be controlled.

### 3. HARDWARE CONFIGURATION

The operations by the above described information processing apparatus 100 are implemented by cooperation between a hardware configuration included in the information processing apparatus 100 and software. Accordingly, hereinafter a hardware configuration of the information process apparatus 100 will be described.

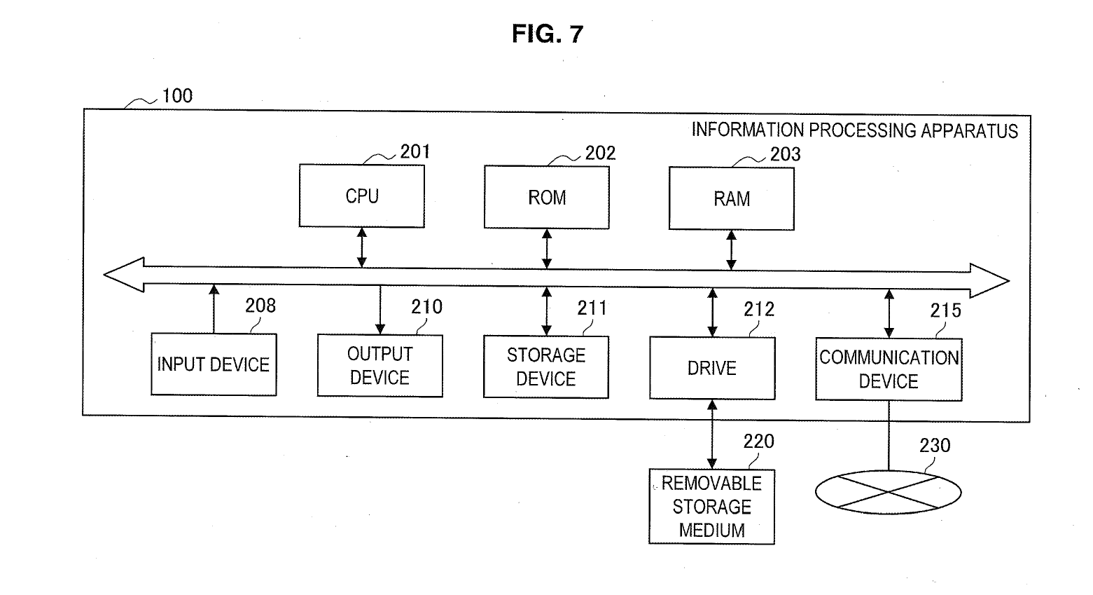

FIG. 7 is an explanatory diagram which shows a hardware configuration example of the information processing apparatus 100 according to the embodiments of the present disclosure. As shown in FIG. 7, the information processing apparatus 100 includes a CPU (Central Processing Unit) 201, a ROM (Read Only Memory) 202, a RAM (Random Access Memory) 203, an input device 208, an output device 210, a storage device 211, a drive 212, and a communication device 215.

The CPU 201 functions as an operation processing apparatus and a control apparatus, and controls all operations within the image processing apparatus 100, in accordance with various programs. Further, the CPU 201 may be a microprocessor. The ROM 202 stores programs and operation parameters used by the CPU 201. The RAM 203 temporarily stores programs used in the execution of the CPU 201, and parameters which arbitrary change in these executions. These sections are mutually connected by a host bus configured from a CPU bus or the like.

The input device 208 includes an input section, such as a mouse, a keyboard, a touch panel, a button, a microphone, a switch, or a leaver, for a user to input information, and an input control circuit which generates an input signal based on an input by the user, and outputs the input signal to the CPU 201. It is possible for the user of the information processing apparatus 100 to input various data for the information processing apparatus 100 by operating the input device 208, and to display the process operations.

The output device 210 includes, for example, a display device such as a liquid crystal display (LCD) apparatus, an OLED (Organic Light Emitting Diode) apparatus, or a lamp. In addition, the output device 210 includes a voice output device such as a speaker or headphones. For example, the display device displays a picked-up image or a generated image. On the other hand, the voice output device converts voice data and outputs a voice.

The storage device 211 is an apparatus for data storage configured as an example of a storage section of the information processing apparatus 100 according to the present embodiments. The storage device 211 may include a storage medium, a recording apparatus which records data to the storage medium, a reading apparatus which reads data from the storage medium, and an erasure apparatus which erases data recorded in the storage medium. This storage device 211 stores the programs executed by the CPU 201 and the various data.

The drive 212 is a reader/writer for the storage medium, and is built into the information processing apparatus 100 or is externally attached. The drive 212 reads information recorded on a removable storage medium 220, such as a mounted magnetic disk, an optical disk, a magneto-optical disk, or a semiconductor memory, and outputs the information to the RAM 203. Further, the drive 212 can write information to the removable storage medium 220.

The communication device 215 is, for example, a communication interface configured by a communication device for connecting to a network 230. Further, even if the communication device 215 is a communication device adaptive to wireless LAN (Local Area Network) or LTE (Long Term Evolution), the communication device 215 may be a wired communication device which communicates by wires.

Note that the network 230 is a wired or wireless transmission line of information transmitted from an apparatus connected to the network 230. For example, the network 230 may include a public network such as the internet, a telephone network or a satellite communication network, or any of a LAN (Local Area Network), WAN (Wide Area Network) or the like including Ethernet (registered trademark). Further, the network 230 may include a leased line network such as an IP-VPN (Internet Protocol—Virtual Private Network).

### 4. CONCLUSION

As described above, the information processing apparatus 100 of the present disclosure identifies a location corresponding to a time difference between the present time and the time of the user's body clock, relative to the user's present position, on a map image displayed on the display section 120. For example, the information processing apparatus 100 displays an avatar which shows the user in a simulated manner at the location corresponding to the time difference.

In this way, the user can intuitively perceive a deviation of his or her body clock, by observing the difference between the position of the avatar and the present position on a map displayed on the display section 120. Further, when the deviation of the body clock is adjusted, the degree of adjustment can be intuitively perceived by observing the position of the avatar displayed on the display section 120. Specifically, the image processing apparatus 100 can be provided which performs various expressions related to a user's body clock and further enhances an entertainment property, by displaying an avatar which shows the user in a simulated manner.

It should be understood by those skilled in the art that various modifications, combinations, sub-combinations and alterations may occur depending on design requirements and other factors insofar as they are within the scope of the appended claims or the equivalents thereof.

While the above described embodiments have a portable terminal such as a smart phone or a mobile phone as an information processing apparatus, it is not limited to this. For example, the information processing apparatus may be a PDA, a game machine, a note PC or the like.

Further, while the information processing apparatus 100 calculates the time difference in the above described embodiments, it is not limited to this. For example, a server capable of communicating with the information processing apparatus 100 through the communication device 215 may calculate the time difference. In such a case, the information processing apparatus 100 displays an avatar on the display section 120, based on a calculation result of the server. In this way, it becomes possible for a user to intuitively recognize the state of his or her body clock while simplifying the configuration of the information processing apparatus 100.

Further, the steps shown in the flow charts of the above described embodiments may of course be processed in chronological order in accordance with the described order, but they may not necessarily be processed in chronological order, and may be processed individually or in a parallel manner. It is needless to say that, in the case where the steps are processed in chronological order, the order of the steps may be changed appropriately according to the circumstances.

The processes by the information processing apparatus described in the present disclosure may be implemented by using any of the combinations of software, hardware, or software and hardware. Programs included in the software are stored, for example, in advance in a storage medium installed inside or outside of each apparatus. Also, each program is read, for example, to a RAM (Random Access Memory) when executed, and is executed by a processor such as a CPU.

Additionally, the present technology may also be configured as below.

(1) An information processing apparatus, including:

a first information acquisition section which acquires position information related to a present position of a user and time information which shows a present time at the present position;

a second information acquisition section which acquires body clock information related to a body clock based on biological information of the user; and

a display control section which displays a map image on a display section,

wherein the display control section identifies and displays a location corresponding to a time difference between the present time and a time of the body clock, with respect to the present position, on the map image.

(2) The information processing apparatus according to (1),

wherein the display control section displays an avatar at the identified location.

(3) The information processing apparatus according to (2),

wherein the display control section changes a display mode of the avatar according to a fluctuation in the time difference.

(4) The information processing apparatus according to (3),

wherein the display control section changes the display mode of the avatar according to a fluctuation in the time difference within a predetermined time period in which the user is using the information processing apparatus.

(5) The information processing apparatus according to any one of (2) to (4),

wherein a position of the avatar on the map image changes according to the time difference, and

wherein the display control section displays advice information for positioning the position of the avatar at the present position.

(6) The information processing apparatus according to any one of (1) to (5),

wherein the display control section displays information related to the body clock and to health.

(7) The information processing apparatus according to any one of (1) to (6),

wherein the display control section displays region information related to the identified location.

(8) The information processing apparatus according to any one of (1) to (7),

wherein the map image is an image which shows a world map.

(9) The information processing apparatus according to (8),

wherein the map image includes a northern hemisphere and a southern hemisphere of an earth, and

wherein the display control section identifies and displays, on the map image, the location corresponding to the time difference on a side of the northern hemisphere or the southern hemisphere which includes the present position.

(10) An information processing method, including:

acquiring position information related to a present position of a user and time information which shows a present time at the present position;

acquiring body clock information related to a body clock based on biological information of the user;

displaying, on a display section, a map image including the present position and a location that includes a time difference with the present position; and

identifying and displaying, on the map image, a location corresponding to a time difference between the present time and a time of the body clock, with respect to the present position.

(11) A program for causing a computer to execute:

acquiring position information related to a present position of a user and time information which shows a present time at the present position;

acquiring body clock information related to a body clock based on biological information of the user;

displaying a map image on a display section; and

identifying and displaying, on the map image, a location corresponding to a time difference between the present time and a time of the body clock, with respect to the present position.

The present disclosure contains subject matter related to that disclosed in Japanese Priority Patent Application JP 2012-080994 filed in the Japan Patent Office on Mar. 30, 2012, the entire content of which is hereby incorporated by reference.

What is claimed is:

1. An information processing apparatus, comprising:
a first information acquisition section which acquires position information related to a present position of a user and time information which shows a present time at the present position;
a second information acquisition section which acquires body clock information related to a body clock based on biological information of the user; and
a display control section which displays a map image on a display section,
wherein the display control section identifies and displays a location corresponding to a time difference between the present time and a time of the body clock, with respect to the present position, on the map image.

2. The information processing apparatus according to claim 1,
wherein the display control section displays an avatar at the identified location.

3. The information processing apparatus according to claim 2,
wherein the display control section changes a display mode of the avatar according to a fluctuation in the time difference.

4. The information processing apparatus according to claim 3,
wherein the display control section changes the display mode of the avatar according to a fluctuation in the time difference within a predetermined time period in which the user is using the information processing apparatus.

5. The information processing apparatus according to claim 2,
wherein a position of the avatar on the map image changes according to the time difference, and
wherein the display control section displays advice information for positioning the position of the avatar at the present position.

6. The information processing apparatus according to claim 1,
wherein the display control section displays information related to the body clock and to health.

7. The information processing apparatus according to claim 1,
wherein the display control section displays region information related to the identified location.

8. The information processing apparatus according to claim 1,
wherein the map image is an image which shows a world map.

9. The information processing apparatus according to claim 8,
wherein the map image includes a northern hemisphere and a southern hemisphere of an earth, and
wherein the display control section identifies and displays, on the map image, the location corresponding to the time difference on a side of the northern hemisphere or the southern hemisphere which includes the present position.

10. An information processing method, comprising:
acquiring position information related to a present position of a user and time information which shows a present time at the present position;
acquiring body clock information related to a body clock based on biological information of the user;
displaying, on a display section, a map image including the present position and a location that includes a time difference with the present position; and
identifying and displaying, on the map image, a location corresponding to a time difference between the present time and a time of the body clock, with respect to the present position.

11. A program for causing a computer to execute:
acquiring position information related to a present position of a user and time information which shows a present time at the present position;
acquiring body clock information related to a body clock based on biological information of the user;
displaying a map image on a display section; and
identifying and displaying, on the map image, a location corresponding to a time difference between the present time and a time of the body clock, with respect to the present position.
